(19) United States
(12) Patent Application Publication
(10) Pub. No.: US 2026/0012030 A1
(43) Pub. Date: Jan. 8, 2026

(54) WIRE HARNESS AND METHOD FOR MANUFACTURING THE SAME

(71) Applicants: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(72) Inventors: Keisuke WAKAZONO, Yokkaichi-Shi, Mie (JP); Takeshi HASEGAWA, Yokkaichi-Shi, Mie (JP); Kazuki MASUDA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(21) Appl. No.: 18/879,968

(22) PCT Filed: Jul. 1, 2022
(86) PCT No.: PCT/JP2022/026444

§ 371 Date: Dec. 30, 2024

(51) Int. Cl. H02J 7/00; B60R 16/03

(52) U.S. Cl. CPC H02J 7/00712; B60R 16/03; H02J 7/0068

(57) ABSTRACT

An adjustment unit of an on-board backup control apparatus controls a first charge/discharge unit corresponding to a first power storage portion such as to supply charge current to the first power storage portion in a first state during a first period and perform constant voltage charging with respect to the first power storage portion during a second period following the first period. The adjustment unit controls a second charge/discharge unit corresponding to a second power storage portion such as to establish a second state with respect to the second power storage portion during the first period and supply charge current to the second power storage portion in a third state during the second period, charge current being suppressed in the second state compared to in the first state and being increased in the third state compared to in the second state.

### CROSS-REFERENCE TO RELATED APPLICATIONS

This application is the U.S. national stage of PCT/JP2022/026444 filed on Jul. 1, 2022, the contents of which are incorporated herein.

### TECHNICAL FIELD

The present disclosure relates to an on-board backup control apparatus.

### BACKGROUND

JP 2009-296808A discloses a power storage apparatus that, when the voltage of a main power supply drops, supplies power to a load from a power storage portion that is a backup power supply. This power storage apparatus outputs a charge signal to a charge circuit upon commencement of use of a vehicle. Upon receiving the charge signal, the charge circuit charges the power storage portion with power from the main power supply.

In a case such as that in which an endeavor is made to increase the redundancy of power supply to a load in a power storage apparatus such as that disclosed in JP 2009-296808A, it would be conceivable to provide a plurality of power storage portions that are backup power supplies. However, the load on the power storage apparatus would increase should charge current having the same magnitude as charge current conventionally supplied to a single power storage portion be supplied to each of the plurality of power storage portions.

The present disclosure aims to reduce the load on an on-board power supply system during a charge operation.

### SUMMARY

An on-board backup control apparatus that is one aspect of the present disclosure is an on-board backup control apparatus for use in an on-board power supply system that includes a first power supply unit and a second power supply unit that includes a plurality of power storage portions, the on-board backup control apparatus performing a backup operation of supplying power to a load based on power from the second power supply unit at least when power supply from the first power supply unit to the load fails, the on-board backup control apparatus including a plurality of charge units that each perform an operation of supplying charge current based on power supplied from the first power supply unit; and an adjustment unit that controls the plurality of charge units, wherein each of the charge units performs an operation of supplying charge current to a corresponding one of the power storage portions, and the adjustment unit controls the charge unit corresponding to a subset of the plurality of power storage portions such as to supply charge current to the subset of power storage portions in a first state during a first period and perform constant voltage charging with respect to the subset of power storage portions during a second period following the first period; and controls the charge unit corresponding to another subset of the plurality of power storage portions that is different from the subset of power storage portions such as to establish a second state with respect to the other subset of power storage portions during the first period and supply charge current to the other subset of power storage portions in a third state during the second period, charge current being suppressed in the second state compared to in the first state and being increased in the third state compared to in the second state.

### Advantageous Effects

The technique according to the present disclosure can reduce the load on an on-board power supply system during a charge operation.

### BRIEF DESCRIPTION OF DRAWINGS

FIG. 1 is a block diagram schematically illustrating an example of an on-board power supply system including an on-board backup control apparatus in a first embodiment.

FIG. 2 is a flowchart illustrating an example flow of control performed in the on-board backup control apparatus in the first embodiment.

FIG. 3 is a flowchart illustrating an example flow of standby control of a second power supply unit.

FIG. 4 is a timing chart illustrating a temporal change in charge voltages and charge currents of first and second power storage portions in the on-board power supply system in the first embodiment.

FIG. 5 is a timing chart illustrating a temporal change in the charge voltages and the charge currents of the first and second power storage portions in the on-board power supply system in a second embodiment.

FIG. 6 is a block diagram schematically illustrating an example of an on-board power supply system including an on-board backup control apparatus in a third embodiment.

### DETAILED DESCRIPTION OF PREFERRED EMBODIMENTS

Example embodiments of the present disclosure are listed and described below. Note that example aspects one through eight described below may be combined in any way as long as they are not contradictory.

In a first aspect, an on-board backup control apparatus for use in an on-board power supply system that includes a first power supply unit and a second power supply unit that includes a plurality of power storage portions, the on-board backup control apparatus performing a backup operation of supplying power to a load based on power from the second power supply unit at least when power supply from the first power supply unit to the load fails, the on-board backup control apparatus including a plurality of charge units that each perform an operation of supplying charge current based on power supplied from the first power supply unit; and an adjustment unit that controls the plurality of charge units, wherein each of the charge units performs an operation of supplying charge current to a corresponding one of the power storage portions, and the adjustment unit controls the charge unit corresponding to a subset of the plurality of power storage portions such as to supply charge current to the subset of power storage portions in a first state during a first period and perform constant voltage charging with respect to the subset of power storage portions during a second period following the first period; and controls the charge unit corresponding to another subset of the plurality of power storage portions that is different from the subset of power storage portions such as to establish a second state with respect to the other subset of power storage portions during the first period and supply charge current to the other subset of power storage portions in a third state during the second period, charge current being suppressed in the second state compared to in the first state and being increased in the third state compared to in the second state.

The on-board backup control apparatus according to the first aspect, during the first period, supplies charge current to a subset of the plurality of power storage portions in the first state and establishes the second state, in which charge current is suppressed compared to in the first state, with respect to another subset of power storage portions that is different from the subset of power storage portions. Thus, during the first period, the load applied to the on-board power supply system can be reduced as a result of charge current to the other subset of power storage portions being suppressed. On the other hand, during the second period, it can be readily ensured that a sufficient amount of charge current is supplied to the other subset of power storage portions as a result of charge current being supplied to the other subset of power storage portions in the third state, in which charge current is increased compared to in the second state. Accordingly, the load on the on-board power supply system during a charge operation can be reduced while ensuring that charge current is supplied in sufficient amounts to the plurality of power storage portions.

In a second aspect, the on-board backup control apparatus according to the first aspect, including the following feature(s). The adjustment unit controls the charge operations by the plurality of charge units such as to keep a total value of charge current supplied to the plurality of power storage portions within a permissible range.

The on-board backup control apparatus according to the second aspect can supply power from the first power supply unit such that charge current is within the permissible range. Thus, the load applied to the on-board power supply system can be reduced by appropriately setting the permissible range of charge current.

In a third aspect, the on-board backup control apparatus according to the first or the second aspect, including the following feature(s). The adjustment unit: controls the charge unit corresponding to the subset of power storage portions such as to perform constant current charging with respect to the subset of power storage portions during the first period and perform constant voltage charging with respect to the subset of power storage portions during the second period; and controls the charge unit corresponding to the other subset of power storage portions such as to stop charging the other subset of power storage portions during at least part of the first period and charge the other subset of power storage portions during the second period.

The on-board backup control apparatus according to the third aspect can reduce the load applied to the on-board power supply system because, as a result of charging of the other subset of power storage portions being stopped during at least part of the first period, charge current to the other subset of power storage portions is reliably suppressed during the part of the first period.

In a fourth aspect, the on-board backup control apparatus according to the first or the second aspect, including the following feature(s). The adjustment unit: controls the charge unit corresponding to the subset of power storage portions such as to perform constant current charging with respect to the subset of power storage portions during a predetermined constant current period within the first period and perform constant voltage charging with respect to the subset of power storage portions during the second period; and performs constant current charging in a suppressed state compared to in the first state with respect to the other subset of power storage portions during at least part of the predetermined constant current period, and performs constant current charging in a state in which charge current is increased compared to in the second state with respect to the other subset of power storage portions during at least part of the second period.

The on-board backup control apparatus according to the fourth aspect performs constant current charging in a suppressed state compared to in the first state (the state of charge current for the subset of power storage portions) with respect to the other subset of power storage portions during at least part of the predetermined constant current period (period during which constant current charging is performed with respect to the subset of power storage portions) within the first period. Thus, during at least part of the predetermined constant current period, it can be ensured that a certain amount of charge current is supplied to the other subset of power storage portions while the load applied to the on-board power supply system is reduced as a result of charge current supplied to the other subset of power storage portions being suppressed.

In a fifth aspect, the on-board backup control apparatus according to the first or the second aspect, including the following feature(s). The adjustment unit: performs first constant current charging with respect to the subset of power storage portions during a first constant current period within the first period, and performs second constant current charging in which current is suppressed compared to in the first constant current charging with respect to the subset of power storage portions during a second constant current period within the first period that follows the first constant current period; and stops charging the other subset of power storage portions during the first constant current period, performs third constant current charging in which current is suppressed compared to in the second constant current charging with respect to the other subset of power storage portions during the second constant current period, and performs fourth constant current charging in which current is increased compared to in the third constant current charging with respect to the other subset of power storage portions during at least part of the second period.

In the on-board backup control apparatus according to the fifth aspect, the load applied to the on-board power supply system is reduced because charging of the other subset of power storage portions is stopped during the first constant current period. The load applied to the on-board power supply system is also reduced during the second constant current period because the third constant current charging, in which current is suppressed compared to in the second constant current charging, is performed with respect to the other subset of power storage portions. During at least part of the second period, it can be readily ensured that a sufficient amount of charge current is supplied to the other subset of power storage portions as a result of the fourth constant current charging, in which current is increased compared to in the third constant current charging, being performed.

In a sixth aspect, the on-board backup control apparatus according to the fifth aspect, including the following feature(s). The adjustment unit increases charge current supplied to the other subset of power storage portions in the fourth constant current charging so as to be greater than charge current supplied to the subset of power storage portions in the second constant current charging.

In the on-board backup control apparatus according to the sixth aspect, the charge voltage of the other subset of power storage portions can be brought closer to a target charge voltage more quickly in the fourth constant current charging.

In a seventh aspect, the on-board backup control apparatus according to the first through the sixth aspects, including the following feature(s). The load includes a first load and a second load that is different from the first load. A subset of the plurality of charge units performs an operation of supplying charge current to the subset of power storage portions. Another subset of the plurality of charge units that is different from the subset of charge units performs an operation of supplying charge current to the other subset of power storage portions. The on-board backup control apparatus further includes: a first discharge unit that performs an operation of supplying power to the first load based on power supplied from the subset of power storage portions; and a second discharge unit that performs an operation of supplying power to the second load based on power supplied from the other subset of power storage portions. The first load is set as the load of higher priority than the second load.

In the on-board backup control apparatus according to the seventh aspect, the first load, which is of higher priority, can be charged first based on the preset order of priority of the loads.

In an eighth aspect, the on-board backup control apparatus according to the seventh aspect, including the following feature(s). The adjustment unit: transitions to the second period if charge voltage of the subset of power storage portions reaches a threshold voltage as a result of the adjustment unit supplying charge current in the first state to the subset of power storage portions during the first period; and, during the second period, supplies charge current to the subset of power storage portions in a state in which current is suppressed compared to in the first state, and increases charge current supplied to the other subset of power storage portions so as to be greater than charge current supplied in the first period.

In the on-board backup control apparatus according to the eighth aspect, a transition to the second period can be performed in a state in which the charge voltage of the subset of power storage portions is at a sufficient level because the transition is triggered by the charge voltage of the subset of power storage portions reaching the threshold voltage during the first period. Furthermore, during the second period, the other subset of power storage portions can be sufficiently charged.

### First Embodiment

### Configuration of On-Board Power Supply System

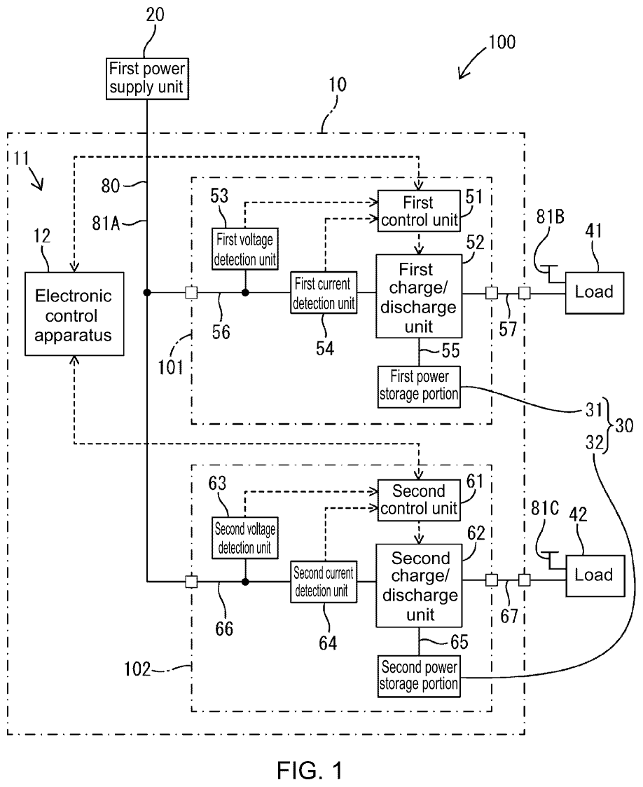

An on-board power supply system 100 illustrated in FIG. 1 includes a first power supply unit 20, a second power supply unit 30, loads 41 and 42, and an on-board backup control apparatus 10. The on-board backup control apparatus 10 is also simply referred to as a backup control apparatus 10.

The first power supply unit 20 functions as a main power supply that continuously supplies power in the event that a vehicle in which the on-board power supply system 100 is installed has been started up. The first power supply unit 20 is a DC power supply that generates a DC voltage. For example, the first power supply unit 20 is formed from a battery such as a lead battery. The high-potential-side terminal and the low-potential-side terminal of the first power supply unit 20 are electrically connected to a power line 80 and the ground, respectively. The first power supply unit 20 applies a predetermined voltage to the power line 80. Note that, in the present description, voltages refer to those referenced to the ground unless otherwise specified.

The first power supply unit 20 is electrically connected to the loads 41 and 42 via the power line 80. Power from the first power supply unit 20 is supplied to the loads 41 and 42 via the power line 80. In the example in FIG. 1, the power line 80 includes a power line 81A that is a conductive path that is directly connected to the first power supply unit 20, a power line 81B that is connected to the load 41, and a power line 81C that is a conductive path that is connected to the load 42. The power lines 81A, 81B, and 81C are electrically connected to one another. In a state in which power is supplied from the first power supply unit 20 to the loads 41 and 42, the power lines 81A, 81B, and 81C have the same potential. An unillustrated relay, fuse, etc., are provided on the power line 80, and these elements have the function of interrupting the electrical continuity of the power line 80.

The loads 41 and 42 are on-board electric devices. The loads 41 and 42 are loads to which power is to be supplied in an abnormal state (failed state) in which power supply from the first power supply unit 20 has stopped. The load 41 corresponds to the “first load” in the present disclosure. The load 42 corresponds to the “second load” in the present disclosure. The first load 41 is set as the load of higher priority than the second load 41. For example, the loads 41 and 42 may each be an actuator such as a motor. Alternatively, the loads 41 and 42 may each be an ECU or an actuator in an electric parking brake system, an ECU or an actuator in a shift-by-wire control system, etc. Alternatively, the loads 41 and 42 may each be an on-board electric device other than those described above.

The backup control apparatus 10 includes an adjustment unit 11, a first charge/discharge unit 52, a first voltage detection unit 53, a second charge/discharge unit 62, and a second voltage detection unit 63. The adjustment unit 11 controls the first charge/discharge unit 52 and the second charge/discharge unit 62. The adjustment unit 11 is provided with an electronic control apparatus 12, a first control unit 51, a first current detection unit 54, a second control unit 61, and a second current detection unit 64. The first charge/discharge unit 52 is an example of a “charge unit” and the “first discharge unit” in the present disclosure. The second charge/discharge unit 62 is an example of a “charge unit” and the “second discharge unit” in the present disclosure.

The electronic control apparatus 12 is a control apparatus different from the first control unit 51 and the second control unit 61. The electronic control apparatus 12 is a control apparatus that is not included in the later-described first power storage unit 101 or second power storage unit 102. For example, the electronic control apparatus 12 is configured as a higher-level Electronic Control Unit (ECU) installed in the vehicle. The electronic control apparatus 12 can communicate with the first control unit 51 and the second control unit 61. The electronic control apparatus 12 controls the first control unit 51 and the second control unit 61.

The backup control apparatus 10 is an apparatus that is capable of performing a backup operation of supplying power to the loads 41 and 42 based on power from the second power supply unit 30 (first power storage portion 31 and second power storage portion 32) in the event of a predetermined state (abnormal state) in which the supply of power from the first power supply unit 20 to the loads 41 and 42 has been interrupted or has decreased.

The on-board power supply system 100 includes a first power storage unit 101 and a second power storage unit 102. The first power storage unit 101 includes a first power storage portion 31, the first control unit 51, the first charge/discharge unit 52, the first voltage detection unit 53, and the first current detection unit 54. The second power storage unit 102 includes a second power storage portion 32, the second control unit 61, the second charge/discharge unit 62, the second voltage detection unit 63, and the second current detection unit 64.

The first power storage portion 31 and the second power storage portion 32 each function as an auxiliary power supply. The first power storage portion 31 and the second power storage portion 32 are examples of “power storage portions” in the present disclosure. Each of the first power storage portion 31 and the second power storage portion 32 is a DC power supply that outputs a DC voltage, and is an electric double-layer capacitor, for example. The first power storage portion 31 is electrically connected to the later-described first charge/discharge unit 52 via a conductive path 55, and is charged and discharged via the first charge/discharge unit 52. The charge voltage (output voltage) of the first power storage portion 31 is applied to the conductive path 55. The high-potential-side terminal of the first power storage portion 31 is electrically connected to the conductive path 55, and has the same potential as the conductive path 55. The low-potential-side terminal of the first power storage portion 31 is electrically connected to the ground, and has the same potential as the ground.

The second power storage portion 32 is electrically connected to the later-described second charge/discharge unit 62 via a conductive path 65, and is charged and discharged via the second charge/discharge unit 62. The charge voltage (output voltage) of the second power storage portion 32 is applied to the conductive path 65. The high-potential-side terminal of the second power storage portion 32 is electrically connected to the conductive path 65, and has the same potential as the conductive path 65. The low-potential-side terminal of the second power storage portion 32 is electrically connected to the ground, and has the same potential as the ground.

In the backup control apparatus 10, the charge voltages (output voltages) of the first power storage portion 31 and the second power storage portion 32 are kept equal to or below a standby voltage in a stationary state in which the startup switch of the vehicle in which the on-board power supply system 100 is installed is off. Furthermore, in response to the startup switch of the vehicle being switched on, the backup control apparatus 10 performs charging such that the charge voltages of the first power storage portion 31 and the second power storage portion 32 exceed or equal a target voltage that is higher than the standby voltage. While the startup switch of the vehicle is on, the charge voltages of the first power storage portion 31 and the second power storage portion 32 are maintained at the target voltage unless the failed state occurs. If the startup switch of the vehicle switches from on to off, the backup control apparatus 10 discharges the first power storage portion 31 and the second power storage portion 32 until the charge voltages of the first power storage portion 31 and the second power storage portion 32 equal or fall below the standby voltage.

The first charge/discharge unit 52 functions such as to supply charge current to the first power storage portion 31 based on power supplied from the first power supply unit 20, and also functions such as to output power based on the first power storage portion 31 to the load 41. The first charge/discharge unit 52 operates based on control by the later-described first control unit 51. The first charge/discharge unit 52 is disposed between a conductive path 56 and a conductive path 57. The conductive path 57 is a conductive path between the first charge/discharge unit 52 and the load 41. The first charge/discharge unit 52 includes a voltage conversion circuit such as a DC-DC converter, for example. The voltage conversion circuit executes a charge operation and a discharge operation with respect to the first power storage portion 31. As the charge operation, the voltage conversion circuit executes a voltage conversion operation of boosting or stepping-down the voltage applied to the conductive path 56 and applying the converted voltage to the conductive path 55. As the discharge operation, the voltage conversion circuit executes a voltage conversion operation of boosting or stepping-down the voltage applied to the conductive path 55 and applying the converted voltage to the conductive path 57.

The second charge/discharge unit 62 functions such as to supply charge current to the second power storage portion 32 based on power supplied from the first power supply unit 20, and also functions such as to output power based on the second power storage portion 32 to the load 42. The second charge/discharge unit 62 operates based on control by the later-described second control unit 61. The second charge/discharge unit 62 is disposed between a conductive path 66 and a conductive path 67. The conductive path 67 is a conductive path between the second charge/discharge unit 62 and the load 42. The second charge/discharge unit 62 includes a voltage conversion circuit such as a DC-DC converter, for example. The voltage conversion circuit executes a charge operation and a discharge operation with respect to the second power storage portion 32. As the charge operation, the voltage conversion circuit executes a voltage conversion operation of boosting or stepping-down the voltage applied to the conductive path 66 and applying the converted voltage to the conductive path 65. As the discharge operation, the voltage conversion circuit executes a voltage conversion operation of boosting or stepping-down the voltage applied to the conductive path 65 and applying the converted voltage to the conductive path 67.

The first control unit 51 controls the operation of supplying power from the first power storage portion 31 to the load 41. The first control unit 51 is an information processing apparatus that has an information processing function, a computing function, a control function, etc. The first control unit 51 is configured using a microcomputer as the main component, for example, and includes a computing device such as a Central Processing Unit (CPU), a memory such as a Read-Only Memory (ROM) or a Random Access Memory (RAM), an AD converter, etc. The first control unit 51 has a function of controlling the first charge/discharge unit 52. The first control unit 51 transmits, to the electronic control apparatus 12, charge current information that allows a charge current value detected by the first current detection unit 54 to be identified. The charge current information may be the charge current value detected by the first current detection unit 54 per se, or may be a value obtained by correcting the charge current value.

The second control unit 61 controls the operation of supplying power from the second power storage portion 32 to the load 42. The second control unit 61 is an information processing apparatus that has an information processing function, a computing function, a control function, etc. The second control unit 61 is configured using a microcomputer as the main component, for example, and includes a computing device such as a Central Processing Unit (CPU), a memory such as a Read-Only Memory (ROM) or a Random Access Memory (RAM), an AD converter, etc. The second control unit 61 has a function of controlling the second charge/discharge unit 62. The second control unit 61 transmits, to the electronic control apparatus 12, charge current information that allows a charge current value detected by the second current detection unit 64 to be identified. The charge current information may be the charge current value detected by the second current detection unit 64 per se, or may be a value obtained by correcting the charge current value.

For example, the first voltage detection unit 53 is configured as a voltage detection circuit. The first voltage detection unit 53 detects the voltage of the conductive path 56. The conductive path 56 is a conductive path that is electrically connected to the power line 80 and has the same potential as the power line 80. Accordingly, the first voltage detection unit 53 is capable of detecting the voltage of the power line 80.

For example, the second voltage detection unit 63 is configured as a voltage detection circuit. The second voltage detection unit 63 detects the voltage of the conductive path 66. The conductive path 66 is a conductive path that is electrically connected to the power line 80 and has the same potential as the power line 80. Accordingly, the second voltage detection unit 63 is capable of detecting the voltage of the power line 80.

For example, the first current detection unit 54 is configured as a current detection circuit. The first current detection unit 54 detects the value of current flowing through the conductive path 56. The first current detection unit 54 detects the value of charge current supplied to the first charge/discharge unit 52. The current value detected by the first current detection unit 54 is a value (specifically, an analog voltage value) that allows the current value of the conductive path 56 to be identified.

For example, the second current detection unit 64 is configured as a current detection circuit. The second current detection unit 64 detects the value of current flowing through the conductive path 66. The second current detection unit 64 detects the value of charge current supplied to the second charge/discharge unit 62. The current value detected by the second current detection unit 64 is a value (specifically, an analog voltage value) that allows the current value of the conductive path 66 to be identified.

### Control by Backup Control Apparatus

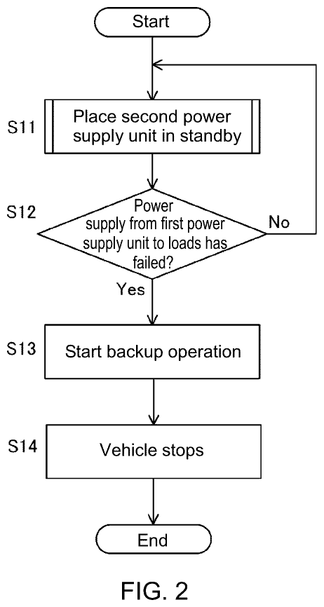

The control illustrated in FIG. 2 is an example of backup control performed by the backup control apparatus 10 (specifically, the adjustment unit 11). The backup control apparatus 10 starts the backup control in FIG. 2 if a predetermined starting condition is met. For example, the condition for starting the backup control in FIG. 2 may be that the startup switch of the vehicle in which the on-board power supply system 100 is installed has been switched from off to on, or a different condition. For example, if the startup switch of the vehicle is switched from off to on, a startup signal indicating that the startup switch has switched on is input to the electronic control apparatus 12. If the electronic control apparatus 12 receives the startup signal, the backup control apparatus 10 starts the backup control in FIG. 2 and causes the first control unit 51 and the second control unit 61 to execute the control described in the following.

Upon commencement of the backup control in FIG. 2, the adjustment unit 11 places the second power supply unit 30 (first power storage portion 31 and second power storage portion 32) in a standby state (step S11). The adjustment unit 11 performs charging such that the charge voltages of the first power storage portion 31 and the second power storage portion 32 exceed or equal the target voltage, which is higher than the standby voltage. The adjustment unit 11 maintains the charge voltages of the first power storage portion 31 and the second power storage portion 32 at the target voltage.

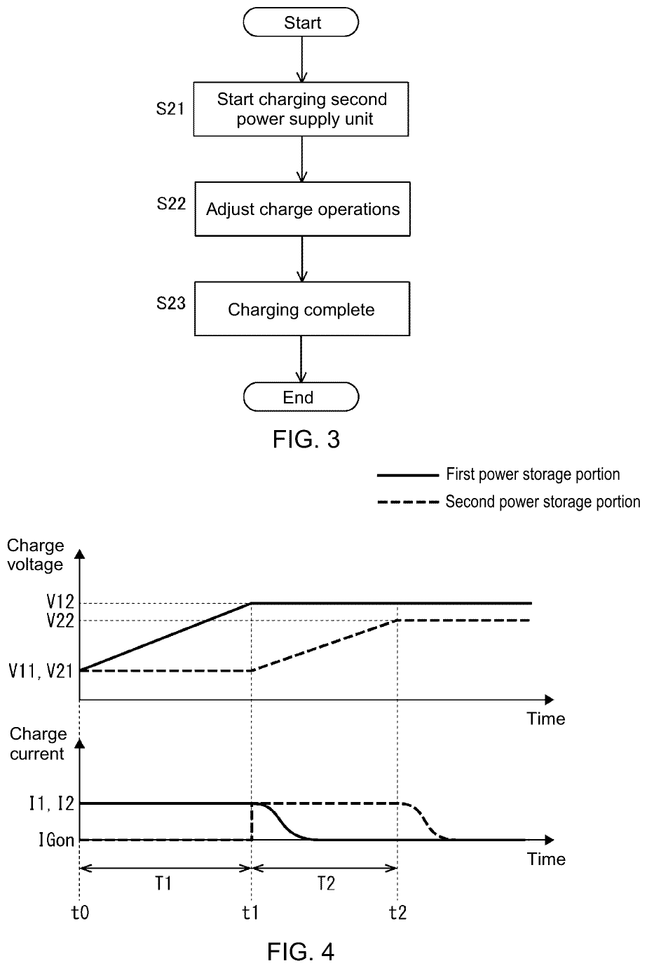

The control illustrated in FIG. 3 is an example of the specific processing in step S11. The adjustment unit 11 starts charging the second power supply unit 30 (first power storage portion 31 and second power storage portion 32) (step S21). The adjustment unit 11 controls the first charge/discharge unit 52 and the second charge/discharge unit 62. The first charge/discharge unit 52 supplies charge current to the first power storage portion 31 based on power supplied from the first power supply unit 20. The second charge/discharge unit 62 supplies charge current to the second power storage portion 32 based on power supplied from the first power supply unit 20.

Subsequently, the adjustment unit 11 adjusts the charge operations by the first charge/discharge unit 52 and the second charge/discharge unit 62 (step S22). As illustrated by the solid-line charts in FIG. 4, the adjustment unit 11 controls the first charge/discharge unit 52 corresponding to a subset of power storage portions (first power storage portion 31) among the plurality of power storage portions (first power storage portion 31 and second power storage portion 32) such as to supply charge current to the subset of power storage portions (first power storage portion 31) in a first state during a first period T1. In the description of the first embodiment, the first power storage portion 31 constitutes a subset of power storage portions, and the second power storage portion 32 constitutes another subset of power storage portions. For example, the first period T1 begins from the time point (t0) when the startup switch of the vehicle is switched from off to on. The first state is a state in which charge current is supplied according to any appropriate control method. Specifically, the first state is a constant current charging state in which the current value I1 illustrated in FIG. 4 is obtained. Note that, for example, the current value of charge current in the first state may change as time elapses.

The first period T1 transitions to a second period T2 once the charge voltage of the first power storage portion 31 reaches a threshold voltage (for example, the voltage V12 illustrated in FIG. 4) as a result of charge current being supplied to the first power storage portion 31 in the first state during the first period T1. The second period T2 begins from time t1 illustrated in FIG. 4. The adjustment unit 11 controls the first charge/discharge unit 52 corresponding to the first power storage portion 31 such as to perform constant voltage charging at a voltage value V12 with respect to the first power storage portion 31 during the second period T2 following the first period T1.

As illustrated by the dashed-line charts in FIG. 4, the adjustment unit 11 controls the second charge/discharge unit 62 corresponding to another subset of power storage portions (second power storage portion 32), among the plurality of power storage portions (first power storage portion 31 and second power storage portion 32), that is different from the subset of power storage portions (first power storage portion 31) such as to establish a second state, in which charge current is suppressed compared to in the first state, with respect to the second power storage portion 32 during the first period T1. The second state is a state in which charging is stopped. Note that the second state may be a constant current charging state in which a current value smaller than the current value Il is obtained. As a result of the charge current to the second power storage portion 32 being suppressed during the first period T1 in such a manner, the load applied to the on-board power supply system 100 during charging can be reduced.

The adjustment unit 11 controls the second charge/discharge unit 62 corresponding to the second power storage portion 32 such as to supply charge current in a third state, in which charge current is increased compared to in the second state, during the second period T2. Specifically, the third state is a constant current charging state in which the current value 12 illustrated in FIG. 4 is obtained. For example, the current value 12 in the third state may be equal in magnitude to the current value I1.

The adjustment unit 11 may control the charge operations of the plurality of charge/discharge units (first charge/discharge unit 52 and second charge/discharge unit 62) such as to keep the total value of charge current supplied to the plurality of power storage portions (first power storage portion 31 and second power storage portion 32) within a permissible range. Specifically, based on the charge current information provided from the first control unit 51 and the second control unit 61, the electronic control apparatus 12 controls the first control unit 51 and the second control unit 61 such as to keep the total value of charge current to the first power storage portion 31 and the second power storage portion 32 within a permissible range. The permissible range is a preset range of current values, and, for example, is a range of current values that are greater than 0 and that are equal to or smaller than the maximum permissible current value in the on-board power supply system 100. For example, the maximum value (permissible threshold) of the permissible range is a value that is smaller than the maximum current value that can flow through a fuse provided on the power line 80 or the like. The permissible threshold is a fixed value, and may be changeable.

Subsequently, in step S23, the backup control apparatus 10 terminates the charging control in FIG. 3 upon determining that the charging of the second power supply unit 30 (first power storage portion 31 and second power storage portion 32) is complete. The backup control apparatus 10 determines that charging is complete if the output voltage of the first power storage portion 31 has reached the target voltage and the output voltage of the second power storage portion 32 has reached the target voltage.

After the charging of the second power supply unit 30 is terminated, the adjustment unit 11 determines whether or not power supply from the first power supply unit 20 (main power supply) to the loads 41 and 42 is in the failed state in step S12 in FIG. 2. An example of a case in which power supply from the first power supply unit 20 is in the failed state is a case in which the voltage of the power line 80 for supplying power from the first power supply unit 20 has equaled or fallen below a threshold voltage. For example, the threshold voltage is a value that is significantly lower than the output voltage that the first power supply unit 20 applies to the power line 80 in a normal state, and is a fixed value that is greater than 0. However, the threshold voltage may be changeable. For example, the first control unit 51 determines whether or not the voltage of the conductive path 56 is lower than the threshold (whether or not the voltage is in a predetermined voltage drop state) based on the voltage detected by the first voltage detection unit 53. The voltage of the conductive path 56 equals approximately 0 V in the abnormal state in which a ground fault or a disconnection has occurred in the power line 80 and power supply from the first power supply unit 20 to the conductive path 56 has ceased. Note that the second control unit 61 may determine whether or not the voltage of the conductive path 66 is lower than the threshold (whether or not the voltage is in a predetermined voltage drop state) based on the voltage detected by the second voltage detection unit 63.

Upon determining that power supply from the first power supply unit 20 to the loads 41 and 42 is in the failed state in step S12, the adjustment unit 11 advances to Yes and executes the processing in step S13. On the other hand, upon determining that power supply from the first power supply unit 20 to the loads 41 and 42 is not in the failed state in step S12, the adjustment unit 11 advances to No and executes the processing in step S11 again.

In step S13, the adjustment unit 11 starts the backup operation. The adjustment unit 11 supplies power from the second power supply unit 30 to the loads 41 and 42. Upon supplying power based on the first power storage portion 31 to the load 41, the first control unit 51 causes an operation to be performed such that a voltage (voltage having a magnitude V1) based on the output voltage of the first power storage portion 31 is applied to the conductive path 57. The voltage V1 is a voltage obtained by boosting or stepping down the output voltage from the first power storage portion 31 using the voltage conversion circuit of the first charge/discharge unit 52. Similarly, upon supplying power based on the second power storage portion 32 to the load 42, the second control unit 61 causes an operation to be performed such that a voltage (voltage having a magnitude V2) based on the output voltage of the second power storage portion 32 is applied to the conductive path 67. The voltage V2 is a voltage obtained by boosting or stepping down the output voltage from the second power storage portion 32 using the voltage conversion circuit of the second charge/discharge unit 62.

The adjustment unit 11 terminates the backup control in FIG. 2 upon determining in subsequent step S14 that the vehicle in which the on-board power supply system 100 is installed is in the stationary state. Specifically, the electronic control apparatus 12 determines whether or not the startup switch of the vehicle in which the on-board power supply system 100 is installed has switched from on to off. For example, a configuration is adopted such that, if the startup switch of the vehicle is switched from on to off, a signal indicating that the startup switch has switched off is provided to the electronic control apparatus 12.

The following explanation relates to an example effect of the present configuration.

The backup control apparatus 10 in the first embodiment, during the first period T1, supplies charge current to a subset of power storage portions (first power storage portion 31) among the plurality of power storage portions in the first state and establishes the second state, in which charge current is suppressed compared to in the first state, with respect to another subset of power storage portions (second power storage portion 32) that is different from the subset of power storage portions. Thus, during the first period T1, the load applied to the on-board power supply system 100 can be reduced as a result of charge current to the other subset of power storage portions (second power storage portion 32) being suppressed. On the other hand, during the second period T2, it can be readily ensured that a sufficient amount of charge current is supplied to the other subset of power storage portions (second power storage portion 32) as a result of charge current being supplied to the other subset of power storage portions (second power storage portion 32) in the third state, in which charge current is increased compared to in the second state. Accordingly, the load on the on-board power supply system 100 during a charge operation can be reduced while ensuring that charge current is supplied in sufficient amounts to the plurality of power storage portions (first power storage portion 31 and second power storage portion 32).

In the backup control apparatus 10 according to the first embodiment, the adjustment unit 11 controls the charge operations by the plurality of charge units (first charge unit 52 and second charge unit 62) such as to keep a total value of charge current supplied to the plurality of power storage portions (first power storage portion 31 and second power storage portion 32) within the permissible range. Thus, power from the first power supply unit 20 can be supplied such that charge current is within the permissible range. Thus, the load applied to the on-board power supply system 100 during charging can be reduced by appropriately setting the permissible range of charge current.

The backup control apparatus 10 in the first embodiment can reduce the load applied to the on-board power supply system 100 during charging because, as a result of charging of the other subset of power storage portions (second power storage portion 32) being stopped during the first period T1, charge current to the other subset of power storage portions (second power storage portion 32) is reliably suppressed during the first period T1.

In the backup control apparatus 10 according to the first embodiment, the first load 41 is set as the load of higher priority than the second load 42. Thus, the first load 41, which is of higher priority, can be charged first based on the preset order of priority of the loads.

In the backup control apparatus 10 according to the first embodiment, the adjustment unit 11 transitions to the second period T2 once the charge voltage of the first power storage portion 31 reaches the threshold voltage during the first period T1. Thus, the transition to the second period T2 can be performed in a state in which the charge voltage of the first power storage portion 31 is at a sufficient level because the transition is triggered by the charge voltage of the first power storage portion 31 reaching the threshold voltage during the first period T1. Furthermore, during the second period T2, the second power storage portion 32 can be sufficiently charged.

### Second Embodiment

The on-board power supply system 100 in the second embodiment differs from that in the first embodiment in terms of the control method of the backup control apparatus 10, and is the same as that in the first embodiment in other regards. Note that the same reference symbol is provided to configurations that are the same as those in the first embodiment, and detailed description thereof is omitted.

### Operation of Backup Control Apparatus

Similarly to the backup control in the first embodiment, the backup control apparatus 10 in the second embodiment executes the control illustrated in FIGS. 2 and 3. The backup control executed by the backup control apparatus 10 (specifically, the adjustment unit 11) in the second embodiment differs from that in the first embodiment mainly in terms of the charge control (step S22) illustrated in FIG. 3. Thus, only the processing in the charge control (step S22) illustrated in FIG. 3 will be described.

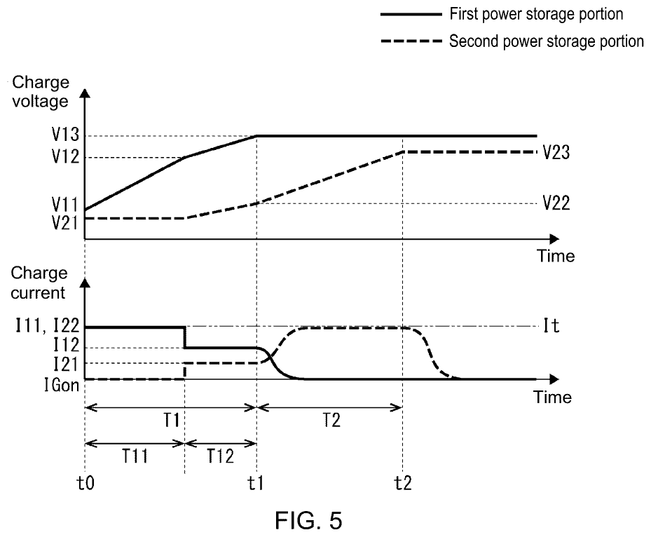

In step S22, the adjustment unit 11 adjusts the charge operations by the first charge/discharge unit 52 and the second charge/discharge unit 62. As illustrated by the solid-line timing charts in FIG. 5, the adjustment unit 11 controls the first charge/discharge unit 52 corresponding to a subset of power storage portions (first power storage portion 31) among the plurality of power storage portions (first power storage portion 31 and second power storage portion 32) such as to supply charge current to the subset of power storage portions (first power storage portion 31) in a first state during a first period T1. In the description of the second embodiment, the first power storage portion 31 constitutes a subset of power storage portions, and the second power storage portion 32 constitutes another subset of power storage portions. For example, the first period T1 begins from the time point (t0) when the startup switch of the vehicle is switched from off to on. The first period T1 is an example of the “predetermined constant current period” in the present disclosure. The first state is a constant current charging state.

Specifically, the adjustment unit 11 causes first constant current charging to be performed with respect to the first power storage portion 31 during a first constant current period T11 within the first period T1. The first constant current charging is a state in which constant current charging is performed at the current value I11 illustrated in FIG. 5. The adjustment unit 11 causes second constant current charging in which current is suppressed compared to in the first constant current charging to be performed with respect to the first power storage portion 31 during a second constant current period T12 within the first period T1 that follows the first constant current period T11. The second constant current charging is a state in which constant current charging is performed at the current value I12 illustrated in FIG. 5, which is smaller than the current value I11.

The first period T1 transitions to a second period T2 once the charge voltage of the first power storage portion 31 reaches the threshold voltage as a result of charge current being supplied to the first power storage portion 31 in the first state during the first period T1. The second period T2 begins from time t1 illustrated in FIG. 5. The adjustment unit 11 controls the first charge/discharge unit 52 corresponding to the first power storage portion 31 such as to perform constant voltage charging at a voltage value V13 with respect to the first power storage portion 31 during the second period T2 following the first period T1.

As illustrated by the dashed-line timing charts in FIG. 5, the adjustment unit 11 controls the second charge/discharge unit 62 corresponding to another subset of power storage portions (second power storage portion 32), among the plurality of power storage portions (first power storage portion 31 and second power storage portion 32), that is different from the subset of power storage portions (first power storage portion 31) such as to establish a second state, in which charge current is suppressed compared to in the first state, with respect to the second power storage portion 32 during the first period T1. The second state is a state in which constant current charging in which charge current is suppressed compared to in the first state is performed. As a result of the charge current to the second power storage portion 32 being suppressed during the first period T1 in such a manner, the load applied to the on-board power supply system 100 during charging can be reduced.

Specifically, the adjustment unit 11 stops charging the second power storage portion 32 during the first constant current period T11. The first constant current period T11 is example of “part of the predetermined constant current period” in the present disclosure. Subsequently, the adjustment unit 11 causes third constant current charging in which current is suppressed compared to in the second constant current charging to be performed with respect to the second power storage portion 32 during the second constant current period T12. The third constant current charging is a state in which constant current charging is performed at the current value I21 illustrated in FIG. 5, which is smaller than the current value 112.

The adjustment unit 11 controls the second charge/discharge unit 62 corresponding to the second power storage portion 32 such as to supply charge current in a third state, in which charge current is increased compared to in the second state, during the second period T2. The third state is a state in which fourth constant current charging in which current is increased compared to in the third constant current charging is performed. The fourth constant current charging is a constant current charging state in which the current value 122 illustrated in FIG. 5, which is greater than the current value I21 in the third constant current charging, is obtained. For example, the current value 122 in the fourth constant current charging may be equal in magnitude to the current value I11.

The adjustment unit 11 increases charge current supplied to the second power storage portion 32 in the fourth constant current charging so as to be greater than charge current supplied to the first power storage portion 31 in the second constant current charging. Specifically, as illustrated in FIG. 5, the adjustment unit 11 increases the current value 122 in the fourth constant current charging so as to be greater than the current value 112 in the second constant current charging.

The adjustment unit 11 controls the charge operations of the plurality of charge/discharge units (first charge/discharge unit 52 and second charge/discharge unit 62) such as to keep the total value of charge current supplied to the plurality of power storage portions (first power storage portion 31 and second power storage portion 32) within a permissible range. Specifically, based on the charge current information provided from the first control unit 51 and the second control unit 61, the electronic control apparatus 12 controls the first control unit 51 and the second control unit 61 such as to keep the total value of charge current to the first power storage portion 31 and the second power storage portion 32 within a permissible range. The permissible range is a preset range of current values, and, for example, is a range of current values that are greater than 0 and that are equal to or smaller than the maximum permissible current value in the on-board power supply system 100. For example, the maximum value (permissible threshold) of the permissible range is a value that is smaller than the maximum current value that can flow through a fuse provided on the power line 80 or the like. The permissible threshold is a fixed value, and may be changeable.

For example, the adjustment unit 11 controls the first charge portion 52 and the second charge portion 62 such that the total of the current value 112 in the second constant current charging with respect to the first power storage portion 31 and the current value I21 in the third constant current charging with respect to the second power storage portion 32 during the second constant current period T12 illustrated in FIG. 5 equals or falls below a permissible current value It.

The following explanation relates to an example effect of the present configuration.

The backup control apparatus 10 in the second embodiment performs constant current charging in a suppressed state compared to in the first state (the state of charge current for the first power storage portion 31) with respect to the second power storage portion 32 during the second constant current period T12 within the first period T1. Thus, during the second constant current period T12, it can be ensured that a certain amount of charge current is supplied to the second power storage portion 32 while the load applied to the on-board power supply system 100 is reduced as a result of charge current supplied to the second power storage portion 32 being suppressed.

In the backup control apparatus 10 in the second embodiment, the adjustment unit 11: performs first constant current charging with respect to the subset of power storage portions (first power storage portion 31) during a first constant current period T11 within the first period T1, and performs second constant current charging in which current is suppressed compared to in the first constant current charging with respect to the subset of power storage portions (first power storage portion 31) during a second constant current period T12 within the first period T1 that follows the first constant current period T11; and stops charging the other subset of power storage portions (second power storage portion 32) during the first constant current period T11, performs third constant current charging in which current is suppressed compared to in the second constant current charging with respect to the other subset of power storage portions (second power storage portion 32) during the second constant current period T12, and performs fourth constant current charging in which current is increased compared to in the third constant current charging with respect to the other subset of power storage portions (second power storage portion 32) during the second period T2. Thus, the load applied to the on-board power supply system 100 is reduced because charging of the other subset of power storage portions (second power storage portion 32) is stopped during the first constant current period T11. The load applied to the on-board power supply system 100 is also reduced during the second constant current period T12 because the third constant current charging, in which current is suppressed compared to in the second constant current charging, is performed with respect to the other subset of power storage portions (second power storage portion 32). During the second period T2, it can be readily ensured that a sufficient amount of charge current is supplied to the other subset of power storage portions (second power storage portion 32) as a result of the fourth constant current charging, in which current is increased compared to in the third constant current charging, being performed.

In the backup control apparatus 10 in the second embodiment, the adjustment unit 11 increases charge current supplied to the other subset of power storage portions (second power storage portion 32) in the fourth constant current charging so as to be greater than charge current supplied to the subset of power storage portions (first power storage portion 31) in the second constant current charging. Thus, the charge voltage of the other subset of power storage portions (second power storage portion 32) can be brought closer to the target charge voltage more quickly in the fourth constant current charging.

### Third Embodiment

An on-board power supply system 200 in the third embodiment differs from the on-board power supply system 100 in the first and second embodiments in that the electronic control apparatus 12 is not provided, and the first control unit 51 and the second control unit 61 are capable of communicating, and is the same as the on-board power supply system 100 in the first and second embodiments in other regards. Note that the same reference symbol is provided to configurations that are the same as those in the first and second embodiments, and detailed description thereof is omitted.

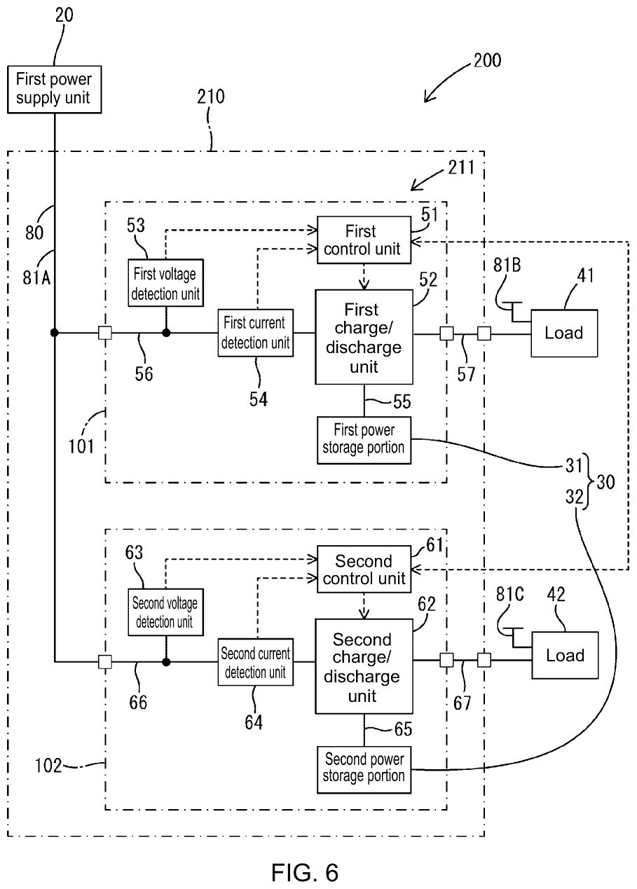

As illustrated in FIG. 6, the on-board power supply system 200 in the third embodiment includes the first power supply unit 20, the second power supply unit 30, the loads 41 and 42, and an on-board backup control apparatus 210. The backup control apparatus 210 includes an adjustment unit 211, the first charge/discharge unit 52, the first voltage detection unit 53, the second charge/discharge unit 62, and the second voltage detection unit 63. The adjustment unit 211 is provided with the first control unit 51, the first current detection unit 54, the second control unit 61, and the second current detection unit 64.

The first control unit 51 and the second control unit 61 can communicate

with one another. The first control unit 51 can transmit, to the second control unit 61, charge current information that allows a charge current value detected by the first current detection unit 54 to be identified. The second control unit 61 can transmit, to the first control unit 51, charge current information that allows a charge current value detected by the second current detection unit 64 to be identified.

### Operation of Backup Control Apparatus

Similarly to the backup control in the first and second embodiments, the backup control apparatus 210 (specifically, the adjustment unit 211) in the third embodiment executes the control illustrated in FIGS. 2 and 3. In the first and second embodiments, the first control unit 51 and the second control unit 61 perform control based on instructions from the electronic control apparatus 12; however, in the third embodiment, the control illustrated in FIGS. 2 and 3 is performed by the first control unit 51 and the second control unit 61. Specifically, in step S22, the first control unit 51 and the second control unit 61 adjust the charge operations by the first charge/discharge unit 52 and the second charge/discharge unit 62 (charge control in the first embodiment (see FIG. 4) or charge control in the second embodiment (see FIG. 5)). For example, the second control unit 61 controls the charge operation of the second charge/discharge unit 62, and also controls the charge operation of the first charge/discharge unit 52 via the first control unit 51. Note that the first control unit 51 may control the charge operation of the first charge/discharge unit 52, and also control the charge operation of the second charge/discharge unit 62 via the second control unit 61.

Because the backup control apparatus 210 in the third embodiment has a configuration in which the first control unit 51 and the second control unit 61 communicate with one another to control the first charge/discharge unit 52 and the second charge/discharge unit 62, there is no need to separately provide a control device that has overall control over the first control unit 51 and the second control unit 61. Thus, charge control can be accomplished solely by the first control unit 51 and the second control unit 61.

### Other Embodiments

The present disclosure is not limited to the embodiments that have been described by way of the drawings and the description above. For example, features of the embodiments described up to this point and in the following can be combined in any way as long as there is no contradiction. Furthermore, the features of the embodiments described up to this point and in the following can also be omitted unless it is explicitly indicated that the features are essential. Furthermore, the above-described embodiments may be modified as follows.

In each of the first to third embodiments described above, the on-board power supply system includes two power storage units (first power storage unit 101 and second power storage unit 102); however, the on-board power supply system may include three or more power storage units having similar configurations. In other words, the second power supply unit 30 may include three or more power storage portions. Three or more control units control corresponding charge/discharge units, and each of the charge/discharge units supplies charge current to the corresponding one of the power storage portions. In such a configuration, for example, a configuration may be adopted such that, in the adjustment of charge operations (step S22 in FIG. 3), control that is the same as that performed during the first period T1 and the second period T2 is sequentially performed for each of the three or more power storage portions.

Furthermore, if three or more power storage units are provided, two or more power storage portions may be selected as the “subset of power storage portions” in the present disclosure, and the same charge control (charge control with respect to the first power storage portion 31) may be performed with respect to the selected power storage portions. Similarly, if three or more power storage units are provided, two or more power storage portions may be selected as the “other subset of power storage portions” in the present disclosure, and the same charge control (charge control with respect to the second power storage portion 32) may be performed with respect to the selected power storage portions.

In the first embodiment described above, the adjustment unit 11 stops charging of the second power storage portion 32 during the first period T1; however, the adjustment unit 11 may stop the charging during part of the first period T1.

In the second embodiment described above, the adjustment unit 11 increases charge current in the third state during the second period T2 compared to that in the second state (current value in the third constant current charging); however, the charge current may be increased during part of the second period T2.

In the first to third embodiments described above, in the backup control by the backup control apparatus, a state in which the voltage of the conductive path 56 is lower than the threshold is described as an example of the predetermined state in step S12; however, the predetermined state may be a different state. For example, the predetermined state may be a state in which a request for a backup operation has been received from a load (specifically, a state in which at least one of the first control unit 51 and the second control unit 61 has received a signal requesting a backup operation from a load).

In regard to the startup switch of the vehicle described in the first to third embodiments described above, the startup switch may be an ignition switch. Alternatively, the startup switch may be a power switch for starting up an EV system in the case of an electric vehicle or the like.

In the first to third embodiments described above, the first power supply unit 20 is a lead battery; however, there is no limitation to a lead battery. For example, the first power supply unit 20 may be a battery of another type such as a lithium-ion battery, or a power supply such as an alternator or a converter.

In the first to third embodiments described above, the first power storage

portion 31 and the second power storage portion 32 are electric double-layer capacitors; however, the power storage portions are not limited to electric double-layer capacitors. The first power storage portion 31 and the second power storage portion 32 may be power storage portions of another type, such as lithium-ion capacitors or lithium-ion batteries.

In the first to third embodiments described above, the backup control apparatus performs the backup operation if power supply from the power supply unit ceases; however, the backup control apparatus may perform the backup operation such that power supply from the power storage portions is performed in a predetermined state in which power supply has not completely ceased.

Note that it is to be understood that the embodiments disclosed herein are illustrative and are not restrictive in all respects. The scope of the present disclosure is not limited to the embodiments disclosed herein, and is intended to include all modifications that are within the scope of the claims and within the range of equivalents of the claims.

1. An on-board backup control apparatus for use in an on-board power supply system that comprises a first power supply unit and a second power supply unit that includes a plurality of power storage portions, the on-board backup control apparatus performing a backup operation of supplying power to a load based on power from the second power supply unit at least when power supply from the first power supply unit to the load fails, the on-board backup control apparatus comprising:
a plurality of charge units that each perform an operation of supplying charge current based on power supplied from the first power supply unit; and
an adjustment unit that controls the plurality of charge units,
wherein each of the charge units performs an operation of supplying charge current to a corresponding one of the power storage portions, and
the adjustment unit:
controls the charge unit corresponding to a subset of the plurality of power storage portions such as to supply charge current to the subset of power storage portions in a first state during a first period and perform constant voltage charging with respect to the subset of power storage portions during a second period following the first period; and
controls the charge unit corresponding to another subset of the plurality of power storage portions that is different from the subset of power storage portions such as to establish a second state with respect to the other subset of power storage portions during the first period and supply charge current to the other subset of power storage portions in a third state during the second period, charge current being suppressed in the second state compared to in the first state and being increased in the third state compared to in the second state.

2. The on-board backup control apparatus according to claim 1, wherein the adjustment unit controls the charge operations by the plurality of charge units such as to keep a total value of charge current supplied to the plurality of power storage portions within a permissible range.

3. The on-board backup control apparatus according to claim 1,
wherein the adjustment unit:
controls the charge unit corresponding to the subset of power storage portions such as to perform constant current charging with respect to the subset of power storage portions during the first period and perform constant voltage charging with respect to the subset of power storage portions during the second period; and
controls the charge unit corresponding to the other subset of power storage portions such as to stop charging the other subset of power storage portions during at least part of the first period and charge the other subset of power storage portions during the second period.

4. The on-board backup control apparatus according to claim 1,
wherein the adjustment unit:
controls the charge unit corresponding to the subset of power storage portions such as to perform constant current charging with respect to the subset of power storage portions during a predetermined constant current period within the first period and perform constant voltage charging with respect to the subset of power storage portions during the second period; and
performs constant current charging in a suppressed state compared to in the first state with respect to the other subset of power storage portions during at least part of the predetermined constant current period, and performs constant current charging in a state in which charge current is increased compared to in the second state with respect to the other subset of power storage portions during at least part of the second period.

5. The on-board backup control apparatus according to claim 1,
wherein the adjustment unit:
performs first constant current charging with respect to the subset of power storage portions during a first constant current period within the first period, and performs second constant current charging in which current is suppressed compared to in the first constant current charging with respect to the subset of power storage portions during a second constant current period within the first period that follows the first constant current period; and
stops charging the other subset of power storage portions during the first constant current period, performs third constant current charging in which current is suppressed compared to in the second constant current charging with respect to the other subset of power storage portions during the second constant current period, and performs fourth constant current charging in which current is increased compared to in the third constant current charging with respect to the other subset of power storage portions during at least part of the second period.

6. The on-board backup control apparatus according to claim 5, wherein the adjustment unit increases charge current supplied to the other subset of power storage portions in the fourth constant current charging so as to be greater than charge current supplied to the subset of power storage portions in the second constant current charging.

7. The on-board backup control apparatus according to claim 1,
wherein the load includes a first load and a second load that is different from the first load,
a subset of the plurality of charge units performs an operation of supplying charge current to the subset of power storage portions,
another subset of the plurality of charge units that is different from the subset of charge units performs an operation of supplying charge current to the other subset of power storage portions.
the on-board backup control apparatus further comprises:
a first discharge unit that performs an operation of supplying power to the first load based on power supplied from the subset of power storage portions; and
a second discharge unit that performs an operation of supplying power to the second load based on power supplied from the other subset of power storage portions, and
the first load is set as the load of higher priority than the second load.

8. The on-board backup control apparatus according to claim 7,
wherein the adjustment unit:
transitions to the second period if charge voltage of the subset of power storage portions reaches a threshold voltage as a result of the adjustment unit supplying charge current in the first state to the subset of power storage portions during the first period; and
during the second period, supplies charge current to the subset of power storage portions in a state in which current is suppressed compared to in the first state, and increases charge current supplied to the other subset of power storage portions so as to be greater than charge current supplied in the first period.

9. The on-board backup control apparatus according to claim 2,
wherein the adjustment unit:
controls the charge unit corresponding to the subset of power storage portions such as to perform constant current charging with respect to the subset of power storage portions during the first period and perform constant voltage charging with respect to the subset of power storage portions during the second period; and
controls the charge unit corresponding to the other subset of power storage portions such as to stop charging the other subset of power storage portions during at least part of the first period and charge the other subset of power storage portions during the second period.

10. The on-board backup control apparatus according to claim 2,
wherein the adjustment unit:
controls the charge unit corresponding to the subset of power storage portions such as to perform constant current charging with respect to the subset of power storage portions during a predetermined constant current period within the first period and perform constant voltage charging with respect to the subset of power storage portions during the second period; and
performs constant current charging in a suppressed state compared to in the first state with respect to the other subset of power storage portions during at least part of the predetermined constant current period, and performs constant current charging in a state in which charge current is increased compared to in the second state with respect to the other subset of power storage portions during at least part of the second period.

11. The on-board backup control apparatus according to claim 2,
wherein the adjustment unit:
performs first constant current charging with respect to the subset of power storage portions during a first constant current period within the first period, and performs second constant current charging in which current is suppressed compared to in the first constant current charging with respect to the subset of power storage portions during a second constant current period within the first period that follows the first constant current period; and
stops charging the other subset of power storage portions during the first constant current period, performs third constant current charging in which current is suppressed compared to in the second constant current charging with respect to the other subset of power storage portions during the second constant current period, and performs fourth constant current charging in which current is increased compared to in the third constant current charging with respect to the other subset of power storage portions during at least part of the second period.

12. The on-board backup control apparatus according to claim 2,
wherein the load includes a first load and a second load that is different from the first load,
a subset of the plurality of charge units performs an operation of supplying charge current to the subset of power storage portions,
another subset of the plurality of charge units that is different from the subset of charge units performs an operation of supplying charge current to the other subset of power storage portions.
the on-board backup control apparatus further comprises:
a first discharge unit that performs an operation of supplying power to the first load based on power supplied from the subset of power storage portions; and
a second discharge unit that performs an operation of supplying power to the second load based on power supplied from the other subset of power storage portions, and
the first load is set as the load of higher priority than the second load.
